(19) United States
(12) Patent Application Publication
(10) Pub. No.: US 2025/0270670 A1
(43) Pub. Date: Aug. 28, 2025

(54) METHOD FOR LEACHING IRON ELEMENT FROM SULFATE SLAG

(71) Applicant: SICHUAN HUIWEI RONGDA TECHNOLOGY CO., LTD., Mianyang City (CN)

(72) Inventors: Wei ZHANG, Mianyang City (CN); Xiaohui LIU, Mianyang City (CN)

(21) Appl. No.: 18/817,176

(22) Filed: Aug. 27, 2024

(30) Foreign Application Priority Data
Feb. 22, 2024 (CN) 202410196368.3

(51) Int. Cl. C22B 3/08; C22B 3/22

(52) U.S. Cl. CPC C22B 3/08; C22B 3/22

(57) ABSTRACT

Provided is a method for leaching iron element from a sulfate slag. A sulfur dioxide-containing gas is introduced into a mixed system obtained after mixing the sulfate slag with dilute sulfuric acid, such that ferric sulfate generated by a reaction of the sulfate slag and the dilute sulfuric acid is quickly reduced into ferrous sulfate by sulfur dioxide.

### CROSS REFERENCE TO RELATED APPLICATION

This patent application claims the benefit and priority of Chinese Patent Application No. 202410196368.3 filed with the China National Intellectual Property Administration on Feb. 22, 2024, the disclosure of which is incorporated by reference herein in its entirety as part of the present application.

### TECHNICAL FIELD

The present disclosure relates to the technical field of inorganic chemical industry, and in particular to a method for leaching iron element from a sulfate slag.

### BACKGROUND

Sulfate slag is a waste residue left after pyrite is oxidized and calcined to produce sulfur dioxide in the sulfuric acid industry, and generally has an iron content not less than 45%. In recent years, sulfate slag has been used as an iron source in increasing industries; iron element in the sulfate slag is leached with sulfuric acid for subsequent processes.

The iron element in the sulfate slag exists in the form of trivalent iron. When ferric sulfate leached directly with the sulfuric acid accumulates to a certain concentration, a reverse reaction may occur in which hydrolysis is conducted to regenerate ferric oxide and sulfuric acid. Therefore, in the prior art, the sulfate slag is mixed with a reducing agent such as coal and then subjected to reduction roasting in a kiln to convert trivalent iron into divalent iron, and the iron element is then leached with sulfuric acid. Such operations lead to high energy consumption cost on one hand, and inevitable generation of flue gas pollution on the other hand, and also lead to a poor iron leaching rate.

### SUMMARY

In view of this, an object of the present disclosure is to provide a method for leaching iron element from a sulfate slag. In the present disclosure, the method exhibits low energy consumption, environmental friendliness, and high iron leaching rate.

To achieve the above object, the present disclosure provides the following technical solutions:

The present disclosure provides a method for leaching iron element from a sulfate slag, including the following steps:

mixing the sulfate slag with dilute sulfuric acid to obtain a mixed system, and introducing a sulfur dioxide-containing gas into the mixed system under stirring at a temperature of 20° C. to 100° C., and conducting reduction leaching;

wherein the dilute sulfuric acid has a mass concentration of 5% to 45%.

In some embodiments, a mass content of iron in the sulfate slag is not less than 25%.

In some embodiments, a mass ratio of the sulfate slag to the dilute sulfuric acid is in a range of 1:1.5-30.

In some embodiments, the stirring is conducted at a speed of 100 r/min to 300 r/min.

In some embodiments, the sulfur dioxide-containing gas is introduced in an amount of 1 L/min to 1,000 L/min.

In some embodiments, the sulfur dioxide-containing gas comprises one selected from the group consisting of a pure sulfur dioxide gas and a sulfur dioxide-containing tail gas.

In some embodiments, the reduction leaching is conducted for 15 min to 180 min.

In some embodiments, during the reduction leaching, an unreacted sulfur dioxide-containing gas escapes in a form of a tail gas;

the tail gas is absorbed by a sodium hydroxide solution to form a sodium sulfite solution; and

the sodium sulfite solution is subjected to concentration and crystallization in sequence to obtain sodium sulfite.

In some embodiments, the method further comprising, after the reduction leaching, subjecting a resulting system to filtration to obtain a filter residue and a ferrous sulfate solution as a filtrate; and subjecting the ferrous sulfate solution to concentration and crystallization in sequence to obtain a ferrous sulfate crystal.

The present disclosure provides a method for leaching iron element from a sulfate slag, including the following steps: mixing the sulfate slag with dilute sulfuric acid to obtain a mixed system, and introducing a sulfur dioxide-containing gas into the mixed system under stirring at a temperature of 20° C. to 100° C., and conducting reduction leaching; where the dilute sulfuric acid has a mass concentration of 5% to 45%.

A sulfur dioxide-containing gas is introduced into a mixed system obtained after mixing the sulfate slag with dilute sulfuric acid, such that ferric sulfate generated by a reaction of the sulfate slag and the dilute sulfuric acid is directly reduced into ferrous sulfate by sulfur dioxide. This process prevents concentration accumulation of the ferric sulfate, effectively avoiding a reverse reaction, and improving a leaching rate of iron. Further, the method does not include calcination and thus does not require high temperature, such that the method results in no flue gas pollution and shows low energy consumption. In addition, reduction leaching is conducted in a solution, which results in a higher reaction degree than that of a solid-solid phase reaction, thus further improving the leaching rate of iron.

The data of examples in the present disclosure show that a leaching rate of the iron element reaches 85.1% to 85.6%.

### BRIEF DESCRIPTION OF THE DRAWINGS

FIG. 1 shows a flow chart of the method for leaching iron element from a sulfate slag according to an embodiment of the present disclosure.

### DETAILED DESCRIPTION OF THE EMBODIMENTS

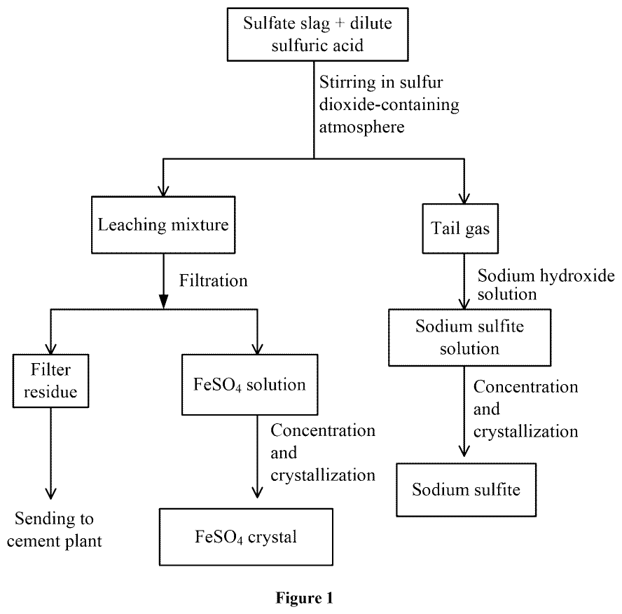

FIG. 1 shows a flow chart of the method for leaching iron element from a sulfate slag according to an embodiment of the present disclosure, and the method provided by the present disclosure is described in detail below in conjunction with FIG. 1.

The present disclosure provides a method for leaching iron element from a sulfate slag, including the following steps:
mixing the sulfate slag with dilute sulfuric acid to obtain a mixed system, and introducing a sulfur dioxide-containing gas into the mixed system under stirring at a temperature of 20° C. to 100° C., and conducting reduction leaching;
wherein the dilute sulfuric acid has a mass concentration of 5% to 45%.

In some embodiments of the present disclosure, the raw materials used herein are all commercially-available products unless otherwise specified.

In some embodiments of the present disclosure, a mass content of iron in the sulfate slag is not less than 25%, preferably not less than 45%, and more preferably 50% to 60%.

In some embodiments of the present disclosure, the dilute sulfuric acid has a mass concentration of 10% to 40%, and preferably 20% to 30%.

In some embodiments of the present disclosure, a mass ratio of the sulfate slag to the dilute sulfuric acid is in a range of 1:1.5-30.

In some embodiments of the present disclosure, the stirring is conducted at a temperature of 50° C. to 60° C. In some embodiments of the present disclosure, the stirring is conducted at a speed of 100 r/min to 300 r/min, and preferably 200 r/min.

In some embodiments of the present disclosure, the sulfur dioxide-containing gas comprises one selected from the group consisting of a pure sulfur dioxide gas and a sulfur dioxide-containing tail gas, and preferably the pure sulfur dioxide gas. In some embodiments of the present disclosure, the sulfur dioxide-containing gas is introduced in an amount of 1 L/min to 1,000 L/min, preferably 1 L/min to 10 L/min, and more preferably 2 L/min to 5 L/min.

In some embodiments of the present disclosure, the reduction leaching is conducted for 15 min to 180 min.

In some embodiments of the present disclosure, wherein during the reduction leaching, an unreacted sulfur dioxide-containing gas escapes in a form of a tail gas; the tail gas is absorbed by a sodium hydroxide solution to form a sodium sulfite solution; and the sodium sulfite solution is subjected to concentration and crystallization in sequence to obtain sodium sulfite. There is no particular limitation on operations of the absorption, concentration, and crystallization, and operations well known to those skilled in the art may be used. In some embodiments of the present disclosure, the sodium sulfite can be used as a commodity in a bleaching agent of printing and dyeing, papermaking and other industries.

In some embodiments of the present disclosure, after the reduction leaching, a resulting system is subjected to filtration to obtain a filter residue and a ferrous sulfate solution as a filtrate.

In some embodiments of the present disclosure, the filter residue is sent to a cement plant.

In some embodiments of the present disclosure, the ferrous sulfate solution is subjected to concentration and crystallization in sequence to obtain a ferrous sulfate crystal; there is no specific limitation on operations of the concentration and crystallization, and operations well known to those skilled in the art can be used.

The method for leaching iron element from a sulfate slag provided by the present disclosure are described in detail below with reference to the examples, but these examples may not be understood as a limitation to the scope of the present disclosure.

### Example 1

500 g of a sulfate slag with an iron content of 59% and 2,500 g of sulfuric acid with a mass concentration of 20% were placed into a flask and stirred at 200 r/min, and a resulting mixture was subjected to heating to a constant temperature of 60° C. SO₂ gas was introduced thereto at 2 L/min, and then a reaction was conducted for 60 min.

A resulting product was subjected to filtration to obtain 2,615 g of a filtrate. After testing, a mass content of divalent iron in the filtrate is 9.6%, and a leaching rate was calculated, being 85.1%.

### Example 2

1,000 g of a sulfate slag with an iron content of 59.8% and 5,000 g of sulfuric acid with a mass concentration of 20% were placed into a flask and stirred at 200 r/min, and a resulting mixture was subjected to heating to a constant temperature of 60° C. SO₂ gas was introduced thereto at 5 L/min, and then a reaction was conducted for 60 min.

A resulting product was subjected to filtration to obtain 5,251 g of a filtrate. After testing, a mass content of divalent iron in the filtrate is 9.75%, and a leaching rate was calculated, being 85.6%.

The above descriptions are merely preferred embodiments of the present disclosure. It should be noted that a person of ordinary skill in the art may further make several improvements and modifications without departing from the principle of the present disclosure, but such improvements and modifications should be deemed as falling within the scope of the present disclosure.

What is claimed is:

1. A method for leaching iron element from a sulfate slag, comprising the following steps:
mixing the sulfate slag with dilute sulfuric acid to obtain a mixed system, and introducing a sulfur dioxide-containing gas into the mixed system under stirring at a temperature of 20° C. to 100° C., and conducting reduction leaching;
wherein the dilute sulfuric acid has a mass concentration of 5% to 45%.

2. The method according to claim 1, wherein a mass content of iron in the sulfate slag is not less than 25%.

3. The method according to claim 1, wherein a mass ratio of the sulfate slag to the dilute sulfuric acid is in a range of 1:1.5-30.

4. The method according to claim 1, wherein the stirring is conducted at a speed of 100 r/min to 300 r/min.

5. The method according to claim 1, wherein the sulfur dioxide-containing gas is introduced in an amount of 1 L/min to 1,000 L/min.

6. The method according to claim 1, wherein the sulfur dioxide-containing gas comprises one selected from the group consisting of a pure sulfur dioxide gas and a sulfur dioxide-containing tail gas.

7. The method according to claim 1, wherein the reduction leaching is conducted for 15 min to 180 min.

8. The method according to claim 1, wherein during the reduction leaching, an unreacted sulfur dioxide-containing gas escapes in a form of a tail gas;
the tail gas is absorbed by a sodium hydroxide solution to form a sodium sulfite solution; and
the sodium sulfite solution is subjected to concentration and crystallization in sequence to obtain sodium sulfite.

9. The method according to claim 1, further comprising, after the reduction leaching, subjecting a resulting system to filtration to obtain a filter residue and a ferrous sulfate solution as a filtrate; and subjecting the ferrous sulfate solution to concentration and crystallization in sequence to obtain a ferrous sulfate crystal.

10. The method according to claim 2, wherein a mass ratio of the sulfate slag to the dilute sulfuric acid is in a range of 1:1.5-30.

11. The method according to claim 5, wherein the sulfur dioxide-containing gas comprises one selected from the group consisting of a pure sulfur dioxide gas and a sulfur dioxide-containing tail gas.
